(19) United States
(12) Patent Application Publication
(10) Pub. No.: US 2005/0141468 A1
(43) Pub. Date: Jun. 30, 2005

(54) Method for establishing channel between user agent and wireless access point in public wireless local area network

(76) Inventors: Se Han Kim, Daejeon-city (KR); Hyun Woo Lee, Daejeon-city (KR); Won Ryu, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/921,598

(22) Filed: Aug. 18, 2004

(30) Foreign Application Priority Data
Dec. 24, 2003 (KR) 2003-96890

(51) Int. Cl. H04Q 7/24

(52) U.S. Cl. 370/338

(57) ABSTRACT

Provided is a method for communication between access points (APs) and for a user agent (UA)'s selecting an AP and establishing a connection by which in establishing a connection between a wireless LAN AP providing a wireless LAN service and the UA in a public wireless LAN service utilizing a wireless LAN technology, a maximum efficiency of the AP a maximum performance of the UA can be obtained. According to the method, the number of user agents connected to a current AP and the amount of traffic being currently processed are compared with the maximum capacity of a neighboring AP and the number of user agents connected to and being serviced by the neighboring AP, to recommend an optimum AP to the user agent. By doing so, the user agent is allowed to comprehensively review information on the number of user agents connected to an adjacent AP and the amount of traffic being processed by the AP as well as reception sensitivity, and then to select an optimum AP.

This application claims the priority of Korean Patent Application No. 2003-96890, filed on Dec. 24, 2003, in the Korean Intellectual Property Office, the disclosure of which is incorporated herein in its entirety by reference.

### BACKGROUND OF THE INVENTION

1. Field of the Invention

The present invention relates to a method for most efficiently managing a wireless access point (AP) providing a public wireless local area network (LAN) service, in establishing a channel between the wireless AP and a user agent (UA).

2. Description of the Related Art

In order to accommodate a number of users in a narrow area, a public wireless LAN provider installs a number of APs and provides faster bandwidths to the users. In order that a user may use the public wireless LAN access service in this environment, a process for establishing a physical channel between a user agent and an AP based on IEEE 802.11 is necessary. In the conventional technology, a user agent selects an AP having a best reception sensitivity of a radio wave, among APs, and is connected to the selected AP.

When the service is provided to a plurality of users at the same time in a hot spot area, the quality of service provided to each user is affected by the number of users connected to an AP and the amount of traffic being processed by the AP. In case that in an environment with a number of APs disposed, user agents access only a certain AP, the usage efficiency of APs is lowered and accordingly, the efficiency of the network is also lowered. In addition, the method for selecting an AP based on the strength of a radio wave, which is the method being currently used, the maximum performance of a user agent cannot be guaranteed.

Recently, communications service providers have introduced wireless LAN technologies that were used indoors, into the public networks. At present, under the name of ultra high-speed wireless Internet services, they are providing Internet services after authenticating user ID registered through a subscription process.

However, even though a number of APs are disposed, in hot spot areas where there are many users, such as train stations, terminals, exhibition centers, and conference rooms, the maximum transmission speed defined in IEEE 802.11 based wireless LAN specifications cannot be guaranteed. In some cases, a lot of users access a certain AP at the same time such that the efficiency of resources is lowered. As a result, the processing performance is lowered with respect to the number of users or the amount of traffic being processed.

### SUMMARY OF THE INVENTION

The present invention provides a method for exchanging message between access points (APs) and for establishing a channel between an AP and a user agent (UA) by which a maximum performance of an AP can be achieved in an environment where a plurality of wireless APs are disposed.

According to an aspect of the present invention, there is provided a method for establishing a channel between a user agent (UA) and a wireless access point (AP) in an environment where a plurality of wireless local area network (LAN) APs are disposed, the method including: the APs broadcasting media access information using beacon frames; the UA transmitting a probe message to the APs; the APs receiving the probe message and transmitting probe response messages to the UA; based on the contents of probe response messages received from the APs, the UA selecting an optimum AP by comparing “the number of user agents connected to a current AP and the amount of traffic currently being processed by the current AP” with “the maximum capacity of a neighboring AP and the number of user agents connected to the neighboring AP”, and transmitting a request message for establishing a channel to the selected AP; and if the UA receives a response message on establishing a channel, from the AP receiving the request message, establishing a channel between the UA and the AP.

According to another aspect of the present invention, there is provided a data structure of a message which is used to transfer information being processed by each AP, to other APs, the data structure being transferred between APs including: a protocol identifier which indicates that the message is for information exchange of the AP; an AP identifier which indicates the SSID of the AP; a supported rate which indicates a maximum link speed supported by the AP; and the number of user agents being serviced by the AP.

According to still another aspect of the present invention, there is provided a wireless LAN AP including: a bridge protocol function unit which performs network setting through a bridge protocol data unit (BPDU); a wireless port state information unit which determines a forwarding state by a spanning tree algorithm, maintains information on the bandwidth of a wireless port and the number of users, and maintain state information of a neighboring AP; and a call admission controller which receives and processes a BPDU for information exchange between AP classified in the bridge protocol function unit, or generates a new BPDU based on wireless port state information.

The BPDU may be used to inform the presence of the AP to other bridges or APs in a network, to transfer information required for forming a spanning tree, and to perform learning, and also used to exchange information on performances of user agents being services by each AP and the performance of each AP.

According to the present invention, in a beacon frame providing media access information by broadcasting to a user agent in the MAC layer of an AP and/or in a probe response message frame, its own AP's information (the number of user agents connected to a current AP and the amount of traffic being currently processed) is compared with the maximum capacity of a neighboring AP and the number of user agents connected to and being serviced by the neighboring AP, and an optimum AP is recommended to the user agent.

By doing so, in addition to selecting an AP according to reception sensitivity, the user agent is enabled to comprehensively review information on the number of user agents connected to an adjacent AP and the amount of traffic being processed by the AP, and then select an optimum AP.

According to an embodiment of the present invention, in order for APs to exchange traffic information, a bridge protocol data unit (BPDU) is used such that a plurality of APs in a hot spot area exchange access information of UAs connected to each APs, and by using this information, the network can be efficiently managed in communication between APs and UAs.

Accordingly, in the present invention, by using the BPDU messages, information is exchanged between APs and based on beacon frames in the wireless LAN MAC layer and option fields of probe response frames, an optimum AP is selected among neighboring APs. In the user agent, by comprehensively reviewing information on reception sensitivity, the number of user agents connected to an AP, and the amount of traffic being processed in the AP, an AP most advantageous in terms of efficiency is selected and a connection to the AP is established. Then, even in hot spot areas where there are a number of users, maximum access efficiency can be achieved.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic diagram showing a system for providing a public wireless LAN service to which the present invention is applied;

FIG. 2 is a schematic diagram of an example of a structure in which a plurality of access points (APs) and user agents are connected to each other in a predetermined region in a hot spot area in a wireless LAN environment;

FIG. 3 is a diagram of the internal structure of an ordinary wireless AP;

FIG. 4 is a block diagram illustrating internal functions of an AP according to the present invention;

FIG. 5 is a detailed table on wireless port state information of FIG. 4;

FIG. 6 is a diagram of the data structure of a bridge protocol data unit (BPDU) message;

FIGS. 7A and 7B are diagrams showing an AP search and connection process by a user agent based on a beacon frame in a wireless LAN environment to which the present invention is applied;

FIGS. 8A and 8B are diagrams showing an active-type AP search and connection process by a user agent in a wireless LAN environment to which the present invention is applied;

FIG. 9 is a diagram of a beacon frame to which the present invention is applied;

FIG. 10 is a diagram of the data structure of a probe response message frame to which the present invention is applied; and

FIGS. 11A through 11C are detailed diagrams of the data structure of information on neighbor AP, which is used in FIGS. 9 and 10.

### DETAILED DESCRIPTION OF THE INVENTION

Hereinafter, the present invention will be described in detail by explaining preferred embodiments of the invention with reference to the attached drawings.

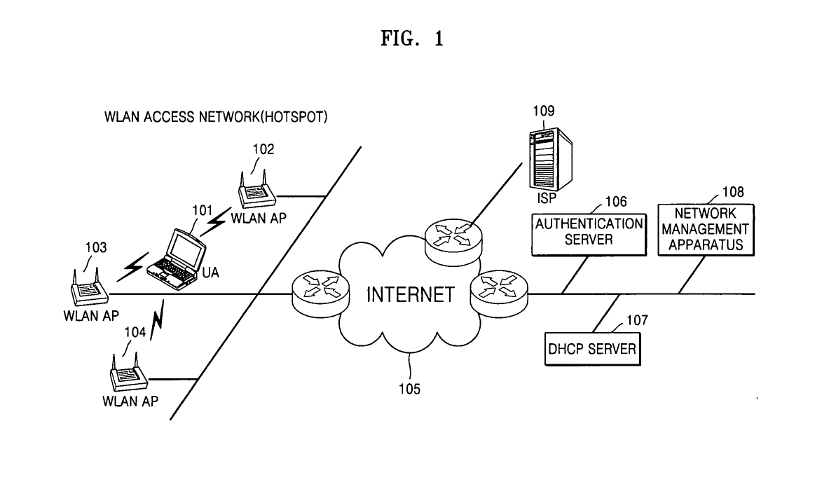

FIG. 1 is a schematic diagram showing a system to provide public wireless LAN service to which the present invention is applied.

In order that wireless LAN based ultra high speed wireless Internet service is provided to a user, a user agent (UA) 101 having a wireless LAN card mounted therein selects one of access points (APs) 102 through 104 connected to the Internet 105. The user agent 101 obtains admission to service access from an authentication server 106 managed by a service provider through the selected AP, and then can access a server 109 of an information provider. The structure of a public wireless LAN service network for this will now be explained. First, in an area where there are a large number of users, a plurality of APs 102 through 104 are installed and APs are connected to the Internet 105 via leased-line-based routers. Also, the service provider manages a DHCP server 107 for allocating IP addresses to UAs and a network management apparatus 108.

The user agent 101 is an ordinary computer apparatus such as a notebook computer, a desktop computer, or a personal digital assistant (PDA) having a personal computer memory card international association (PCMCIA) communication port or a peripheral component interconnect (PCI) slot, on which a wireless LAN card supporting wireless MAC is mounted.

Wireless APs 102 through 104 are connected between a plurality of UAs 101 and routers and perform such functions as bridging between a wireless network and a wired network, forming cells, and roaming between cells such that wireless LAN communication of the UAs can be relayed.

When the UA 101 desires to access the Internet, the wireless LAN card performs data link processing such as obtaining a communication channel complying with wireless LAN standards (for example, IEEE 802.11b). The AP performs authentication for UA's access by receiving the service set identifier (SSID) and wired equivalency privacy (WEP) key information (network authentication information) of the UA, and then allocates a floating IP address or fixed IP address for the UA to access the Internet, by using information (Internet access information) on an already established Internet protocol (IP), gateway, and/or domain name server (DNS). Also, the AP bridges a wireless LAN port to which the UA is connected and a wired LAN port to which the Internet is connected such that the UA is connected to the Internet through the AP and router.

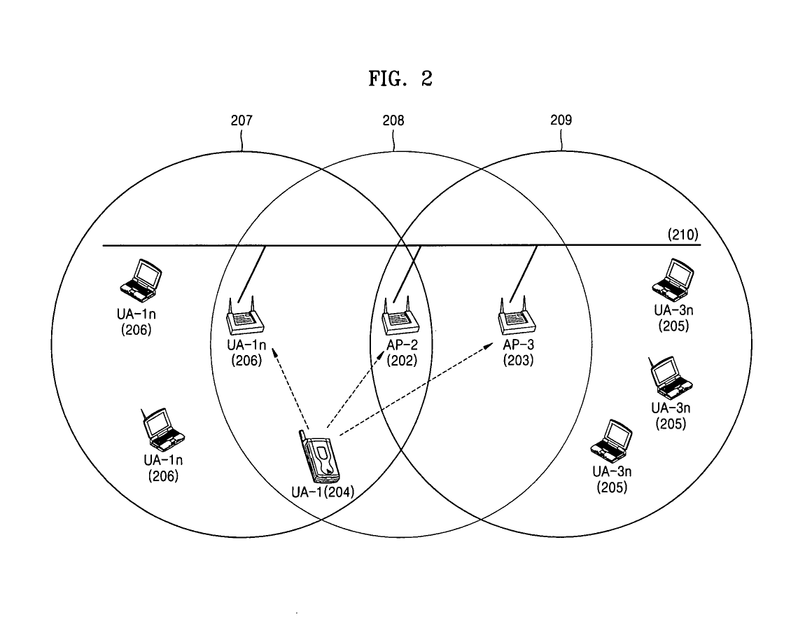

FIG. 2 is a schematic diagram of an example of a structure in which a plurality of APs and UAs are connected to each other in a predetermined region in a hot spot area in a wireless LAN environment based on the IEEE 802.11.

Three APs 201 through 203 have respective serviceable areas that are overlapping each other. Here, in the serviceable area 207 by AP-1 201, a plurality of UA-1n 206 are connected, and in the serviceable area 209 by AP-3 203, a plurality of UA-3n 205 are connected. Also, in the serviceable area 208 by AP-2 202, a plurality of UAs are connected.

In order for a UA to use a wireless Internet service, a process for establishing a physical connection based on the IEEE 802.11 is necessary before performing authentication by a service provider. That is, in order for UA-1 204 to use a wireless LAN service, at a time when power begins to be provided to the UA 204, or when the UA 204 enters a serviceable area 207 through 209 by APs 201 through 203, the UA 204 searches APs, selects an AP considering the strength of a radio wave signal, and then a process for establishing a physical connection with the AP is performed.

In addition, if the UA connected to an AP moves (“roams”) to a serviceable area of another AP, the UA recognizes decrease in radio wave reception sensitivity of the AP currently connected to the UA, and through a process for searching again APs, selects another AP and performs establishing a channel with the AP. The present invention provides a method for allowing the UA to select an AP capable of guaranteeing the maximum performance of the service in this wireless LAN channel establishment process.

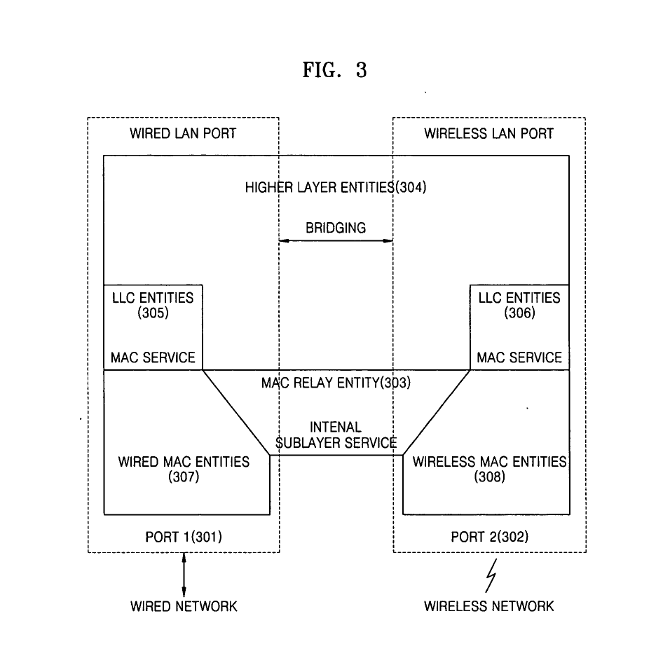

FIG. 3 is a diagram of protocol layers of a wireless AP and to explain the operation of a wireless LAN AP.

A wired MAC layer 307 implemented by a wired LAN card, a wireless MAC layer 308 implemented by a wireless LAN card, higher layer entities 304 collecting MAC address information of all nodes and port state information of communication ports in each node, and performing STA algorithm for bridging, and logic link control (LLC) layers 305 and 306 are shown in FIG. 3. The structure of the MAC header field of frame data transmitted through a wired network is different from that of frame data transmitted through a wireless network. Accordingly, in order to communicate data between a wired network and a wireless network, a process for converting two different MAC header fields is necessary. The bridging process between a wireless network and a wired network includes a learning process, a filtering process, a data conversion process, and a forwarding process.

In the learning process, the source and destination MAC addresses of first frame data received from a wireless network/a wired network, and communication port operation states of the source and destination are confirmed and MAC addresses and port state information of all nodes connected through a wired network or wireless network to the UA are stored in a database. In the filtering process, predetermined transmission route information is stored in a database such that no loop is generated when the first frame data unit is transmitted according to spanning tree algorithm (STA) processing. In the data conversion process, by modifying the MAC header field, the format of the first frame data is converted into the format of a second frame data. In the forwarding process, a forwarding port is determined according to the filtered information, and the second frame unit is transmitted to a corresponding destination. Here, if the first frame data is wired MAC frame data, the second frame data is wireless MAC frame data, and inversely, if the first frame data is wireless MAC frame data, the second frame data is wired MAC frame data.

In the learning process, port state information includes blocking state, learning state, forwarding state, and disabled state of a communication port. When a communication port is in blocking state or disabled state, transmitting frame data to and receiving frame data from the communication port are blocked. The STA processing performed in the filtering process is a process to generate a network topology of a tree structure, and the detailed process is explained in the IEEE 802.1 specification. A single communication route without a loop is established between two UAs connected to a wired network/wireless network according to the STA processing, and the communication port to which the two UAs are connected is transited to forwarding state in which frame data can be transmitted.

A wireless LAN AP has a wireless port 302 and a wired port 301, and performs a bridging function between the ports 302 and 301. Though a bridge for wire link is formed with physical layers in which all ports are appropriate to a wired environment, an AP has an interface for a UA capable of accessing a wireless LAN, while performs the same process for transferring traffic in a higher layer as in the conventional wired bridge.

An AP includes ports 301 and 302, MAC relay entities 303 connecting ports, and higher layer entities 304 such as a bridge protocol layer. Each bridge port should transfer a bridge protocol data unit (BPDU) to the bridge protocol layer and accordingly, performs a function to provide MAC service to the LLC entities 305 and 306.

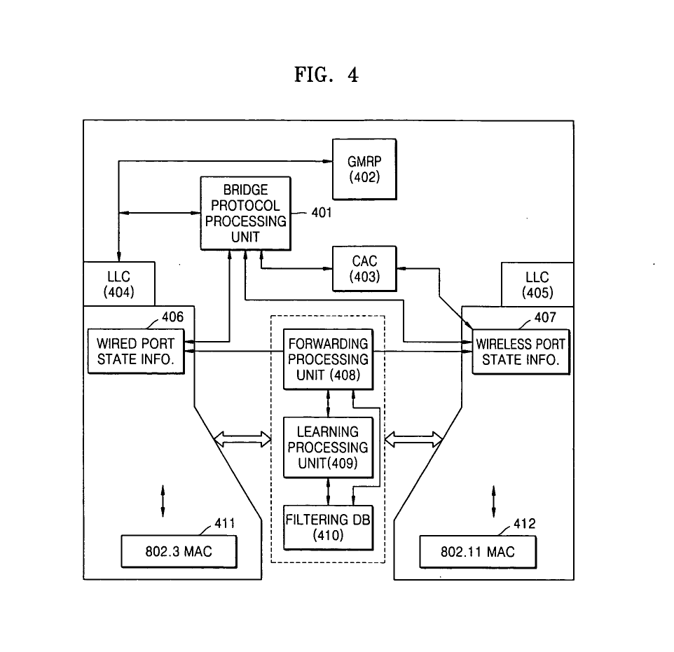

FIG. 4 is a block diagram illustrating internal functions of an AP according to the present invention. A bridge protocol processing unit 401 performs calculation of a bridged LAN topology and setting a network through a BPDU. In addition, services such as bridge management and GMRP 402 are performed through the LLC 404 and 405.

A BPDU is used to inform the presence of the AP to other bridges or APs, to transfer information required for forming a spanning tree, and to perform a learning process. Also, in the present invention, the BPDU is used to exchange information on UAs and APs.

A call admission controller (CAC) 403 receives and processes BPDUs for exchanging information among APs classified in bridge protocol processing unit 401, or generates a new BPDU based on port state information 407 complying with the IEEE 802.11 specification.

Port state information 406 and 407 has states of input and output ports. Wired port state information 406 is information for managing the state of a port such that frames can be relayed only in forwarding state by the spanning tree algorithm. Wireless port state information 407 complying with the 802.11 specification determines forwarding state by the spanning tree algorithm, receives information on the bandwidth of a wireless port and the number of users from a filtering database 410 to maintain the information, and receives state information on a neighboring AP from the CAC 403 to maintain the information.

A forwarding processing unit 408 discards frame data or transmits frame data to a forward port, according to the contents of the filtering database 410 and the state of a port. For example, if the port sate is block state, frame data is discarded.

A learning processing unit 409 registers a source address of a received frame in the filtering database 410. The filtering database 410 has filtering information. Referring to the filtering database 410, the forwarding processing unit 408 determines the destination address (DA) of a port to which a received frame is to be transferred.

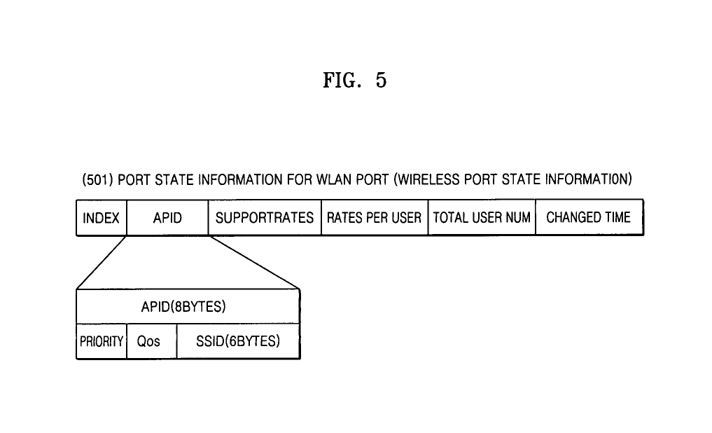

FIG. 5 is a detailed table on wireless port state information 407 of FIG. 4. This table includes information on neighboring APs received from neighboring APs. Index is the number of a data column in the table. AP identifier is formed with 8 bytes, that is, 6 bytes for SSID that is the MAC address of the AP, 1 byte for the priority of the AP, and 1 byte for a flag indicating whether or not QoS of the AP is supported.

Supported rate indicates a maximum link speed supported by the AP. Rates per num is a value obtained by dividing the maximum link speed supported by the current AP by the number of UAs currently accommodated by the AP to indicate a supportable link speed for each UA by the AP. Total user num indicates the number of UAs connected to the AP and Changed Time indicates a time when a data column is changed.

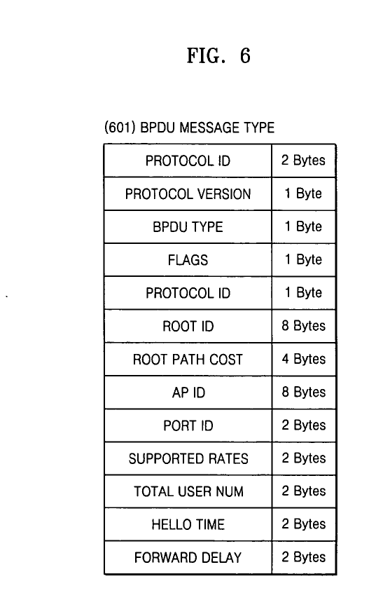

FIG. 6 is a diagram of the data structure of a BPDU message used to transfer information on each AP to another AP.

Each bridge used in a wired network periodically transmits and receives a message referred to as a BPDU to inform the presence of the bridge to other bridges, to transfer information for forming a spanning tree, and to perform learning. A wireless AP supporting a wireless LAN also operates in the same manner as the wired bridge, and exchange information between APs by using a BPDU.

In protocol ID, for example, 0x00000 indicates a spanning tree protocol (STP), and 0xF0F0 indicates that the BPDU is for exchanging information between APs. Protocol version may be set, for example, as 0x00. BPDU type indicates the type of the BPDU. For example, if the BPDU indicates a change in setting a network, it has a value, 0x80, and if the BPDU is for exchanging information between APs, it has a value, 0xF0.

Flags, protocol ID, root ID, root path cost, hello time, and forward delay are the same as in a BPDU for ordinary SPT.

AP identifier (AP ID) is the SSID of the AP, which is the same as the AP identifier explained referred to FIG. 5. Supported rate is a maximum link speed supported by the AP and Total user num is the number of UAs being serviced by the AP.

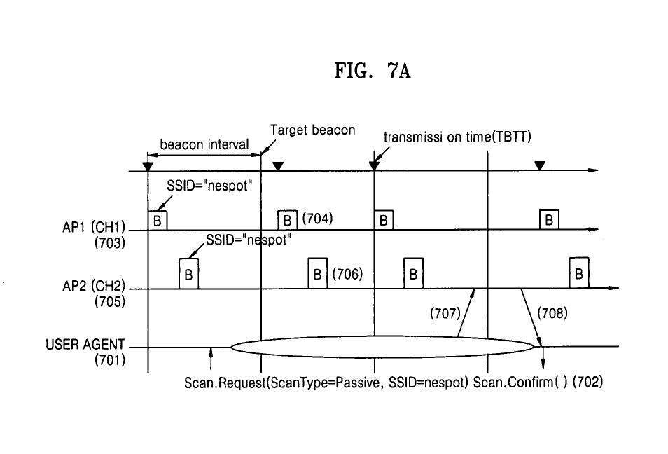

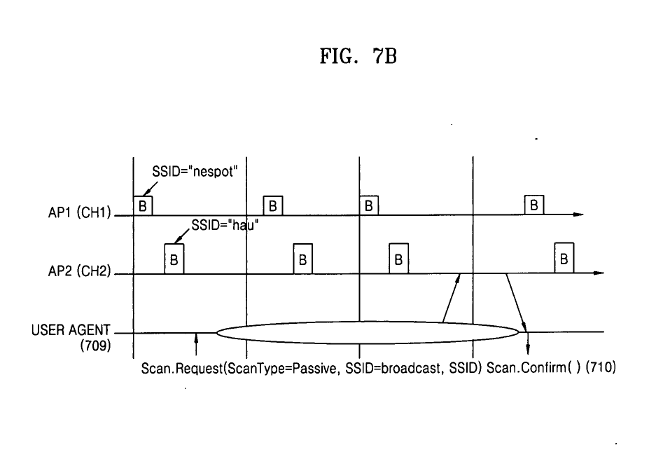

FIGS. 7A and 7B are diagrams showing an AP search and connection process based on a beacon frame in a UA in a wireless LAN environment to which the present invention is applied.

In FIG. 7A, (in case of a specific SSID) in order to determine whether or not SSID value of each channel in the physical layer is identical as “nespot”, the UA 701 compares the beacon frame 704 of AP1 703 and the beacon frame 706 of AP2 705. As a result of the comparison, an optimum AP is selected based on beacon frame information, to transmit a message requesting to establish a channel to the AP in step 707. When the UA 701 receives a response message for establishing a channel from the AP in step 704, a channel between the UA 701 and the AP is established.

In a process for searching APs by a UA 709 of FIG. 7B (in case of not determined SSID), if SSID value is set as broadcast SSID, beacon frames of all channels are received irrespective of SSID value of the AP such that the best AP can be selected.

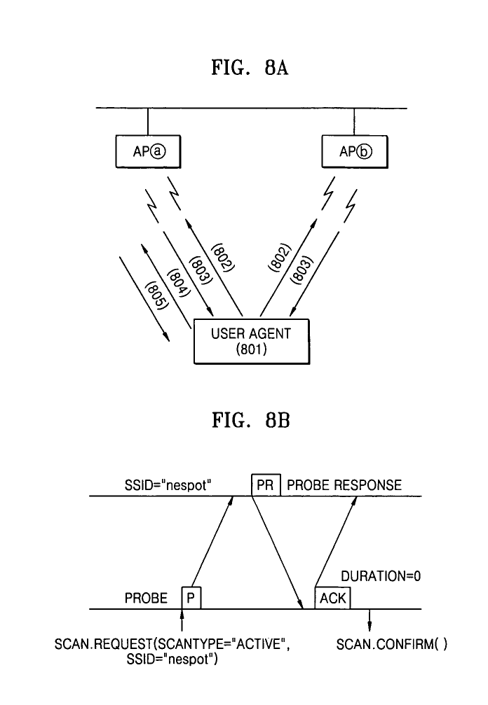

FIGS. 8A and 8B are diagrams showing a process in which a UA actively searches APs and establishes a channel to an AP in an IEEE 802.11-based wireless LAN environment to which the present invention is applied. A UA 801 searches each channel in the physical layer and transmits a probe message to APs whose SSID values are identical as “nespot” in step 802. APs receiving the probe message transmit probe response messages to the UA 801 in step 803. The UA 801 compares contents of probe response messages to select an AP, and transmits a message requesting to establish a channel to the selected AP in step 804. When the UA 801 receives a response message for establishing a channel from the AP in step 805, association of the channel is completed.

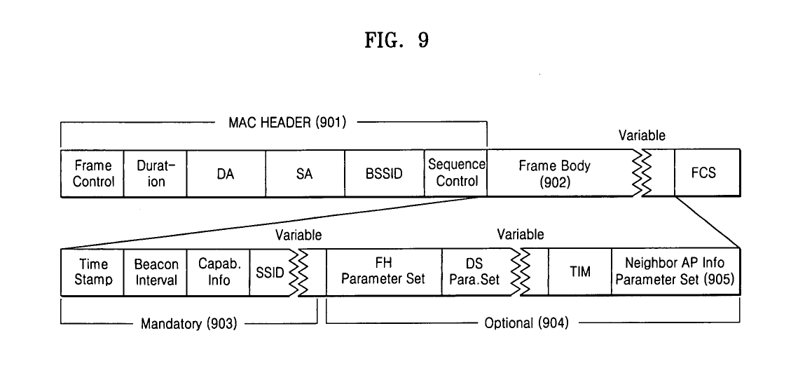

FIG. 9 is a diagram of a beacon frame to which the present invention is applied. The beacon frame is used for the AP search and connection process by a UA explained with reference to FIGS. 7A and 7B.

A general management frame defined in the IEEE 802.11 specification includes a MAC header 901 and a frame body 902. The frame body 902 is a data area used as a beacon frame, and is formed with a mandatory header 903, and an optional header 904 of a variable length. The option header 904 includes a neighbor AP information parameter set 905. The neighbor AP information parameter set 905 is generated based on a detailed table of wireless state information 407 and 501 explained with reference to FIGS. 4 and 5.

In the MAC header 901, frame control (FC) indicates the type of the frame, whether or not power is controlled, and whether or not the frame is encrypted. Duration indicates the occupation time of the frame. DA indicates the destination address, SA indicates the source address, and BSSID is the identifier of a cell formed by an AP. Sequence control indicates whether or not the frame is fragmented.

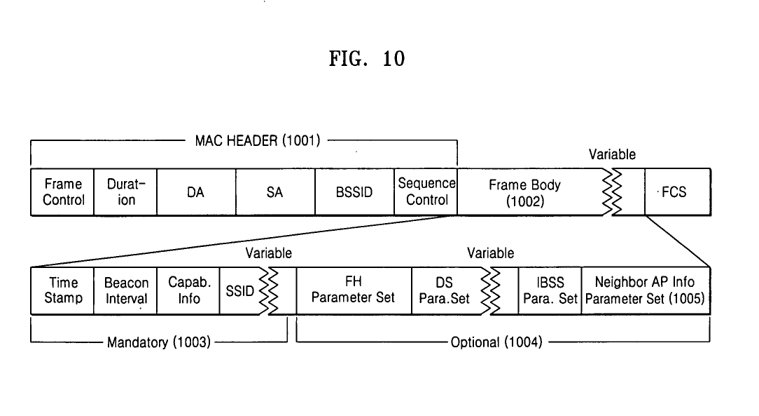

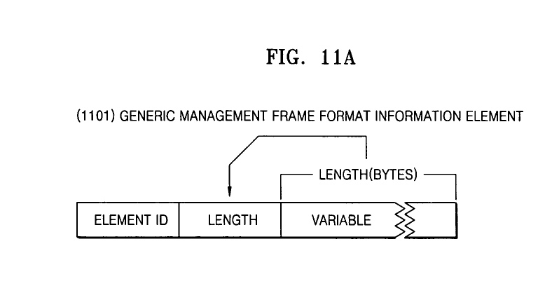

FIG. 10 is a diagram of the data structure of a probe response frame to which the present invention is applied, which is the frame format used for the probe message 802 and the probe response message 803 explained with reference to FIG. 8.

In the general management frame defined in the IEEE 802.11 specification, the frame body 1002 is a data area used as a probe response frame, and is formed with a mandatory header 1003, and an optional header 1004 of a variable length. As explained with reference to FIG. 9, the option header 1004 includes a neighbor AP information parameter set 1005. The neighbor AP information parameter set 1005 is generated based on a detailed table of wireless state information 407 and 501 explained with reference to FIGS. 4 and 5.

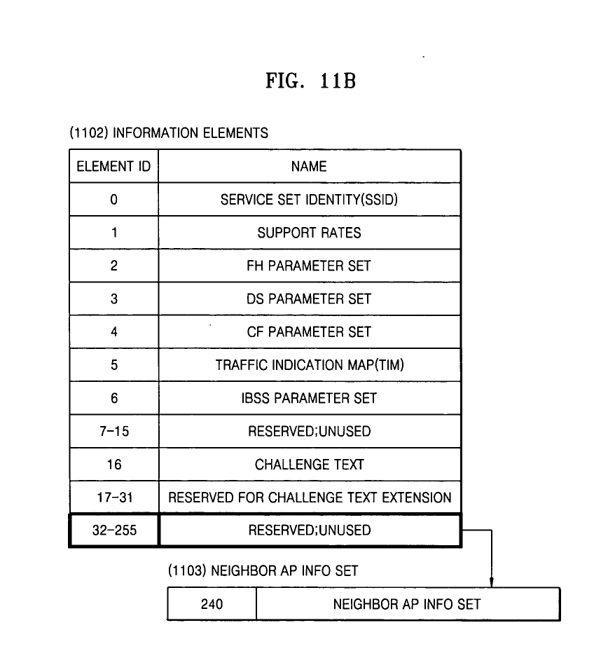

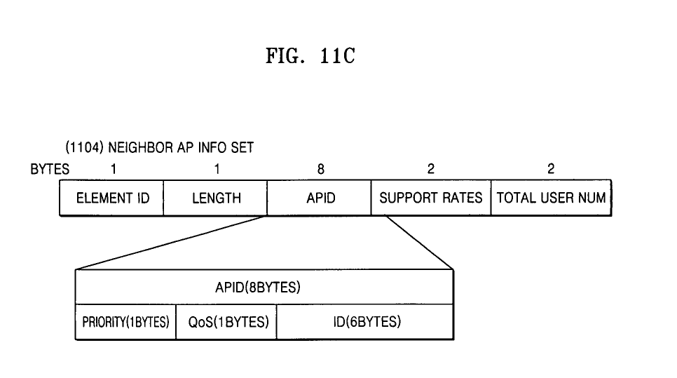

FIGS. 11A through 11C are detailed diagrams of the data structure of neighbor AP info parameter set, which is used in FIGS. 9 and 10. FIG. 11A shows information elements 1101 used as an option header of a variable length in a general management frame, and FIG. 11 B is a table 1102 of elements IDs that are reserved and currently used. In an embodiment of the present invention, by using an element ID (any one of 32-255, for example, 240) that is not used, the neighbor AP info parameter set is transferred. FIG. 11C is the data format of a neighbor AP info parameter set 1104.

The neighbor AP info parameter set 1104 includes AP ID (8 bytes), supported rates (2 bytes) indicating the maximum transmission speed supported by the AP, and total user number (2 bytes) indicating the number of UAs being currently serviced by the AP.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

The preferred embodiments should be considered in descriptive sense only and not for purposes of limitation. Therefore, the scope of the invention is defined not by the detailed description of the invention but by the appended claims, and all differences within the scope will be construed as being included in the present invention.

In a public wireless LAN service based on the IEEE 802.11 specification, in the conventional CSMA/CA media access method, there is the problem that in a hot spot area where there are a number of UAs, it is difficult to guarantee a maximum transmission speed defined in a wireless LAN specification, and in some cases, the performance is rapidly degraded with respect to the number of UAs connected to an AP and the amount of traffic being processed. In particular, when a plurality of APs are disposed in an same area such that frequency bandwidths of the APs do not overlap, if an AP is selected based on only the characteristic of radio wave reception sensitivity, then when users gather together in a certain region, many UAs are connected to only a specific AP, and it can cause undesirable situation to both the users and service providers.

According to the present invention, by using a beacon frame broadcasting media access information from an AP to a UA and a probe response frame, a public wireless LAN AP based on the IEEE 802.11 specification compares the number of UAs connected to the current AP and the amount of traffic being currently processed, with the maximum capacity of a neighboring AP and the number of UAs being currently serviced, and recommends an optimum AP to the UA. By doing so, the UA is allowed to comprehensively review information on the number of user agents connected to an adjacent AP and the amount of traffic being processed by the AP as well as reception sensitivity, and then to select an optimum AP. Accordingly, even in a hot spot environment that should accommodate a plurality of users, a maximum performance can be achieved, a maximum performance can be guaranteed for the user, and AP resources can be utilized to the maximum by the service providers.

1. A method for establishing a channel between a user agent (UA) and a wireless access point (AP) in an environment where a plurality of wireless local area network (LAN) APs are disposed, the method comprising:
the APs broadcasting media access information using beacon frames;
the UA transmitting a probe message to the APs;
the APs transmitting probe response messages to the UA when receiving the probe message;
based on the contents of the probe response messages received from the APs, the UA selecting an optimum AP by comparing “the number of user agents connected to a current AP and the amount of traffic currently being processed by the current AP” with “the maximum capacity of a neighboring AP and the number of user agents connected to the neighboring AP”, and transmitting a request message for establishing a channel to the selected AP; and
when the UA receives a response message on establishing a channel, from the AP receiving the request message, establishing a channel between the UA and the AP.

2. The method of claim 1, wherein the probe response message has an information field of a neighboring AP, and the information field of the neighboring AP comprises:
an AP identifier which indicates the service set identity (SSID) of the AP;
a supported rate which indicates a maximum link speed supported by the AP; and
the number of user agents that are being serviced by the AP.

3. A data structure of a message which is used to transfer information being processed by each AP, to other APs, the data structure being transferred between APs comprising:
a protocol identifier which indicates that the message is for exchanging information between the APs;
an AP identifier which indicates the SSID of the AP;
a supported rate which indicates a maximum link speed supported by the AP; and
the number of user agents being serviced by the AP.

4. A data structure of a probe response message transmitted from a wireless LAN AP to a UA, wherein an option header in the probe response message has an information field on a neighboring AP, the information field comprising:
an AP identifier which indicates the SSID of the AP;
a supported rate which indicates a maximum link speed supported by the AP; and
the number of user agents being serviced by the AP.

5. A wireless LAN AP comprising:
a bridge protocol function unit which performs network setting through a bridge protocol data unit (BPDU);
a wireless port state information unit which determines a forwarding state by a spanning tree algorithm, maintains information on the bandwidth of a wireless port and the number of users, and maintains state information of a neighboring AP; and
a call admission controller which receives and processes a BPDU for exchanging information between APs classified in the bridge protocol function unit, or generates a new BPDU based on wireless port state information.

6. The wireless LAN AP of claim 5, wherein the BPDU is used to inform the presence of the AP to other bridges or APs in a network, to transfer information required for forming a spanning tree, and to perform learning, and also used to exchange information on performances of user agents being services by each AP and the performance of each AP.

7. The wireless LAN AP of claim 5, wherein the state information of a neighboring AP in wireless port state information comprises:
an AP identifier which indicates the SSID of the AP;
a supported rate which indicates a maximum link speed supported by the AP; and
the number of user agents being serviced by the AP.
